(19) United States
(12) Patent Application Publication
(10) Pub. No.: US 2026/0033661 A1
(43) Pub. Date: Feb. 5, 2026

(54) POWDER OUTLET APPARATUS AND MILK POWDER DISPENSER

(71) Applicant: ZhongShan Vision Intelligent Electric Appliance Co., Ltd., Zhongshan (CN)

(72) Inventors: Terry HE, Zhongshan (CN); Patrick LIANG, Zhongshan (CN)

(73) Assignee: ZhongShan Vision Intelligent Electric Appliance Co., Ltd., Zhongshan (CN)

(21) Appl. No.: 19/290,400

(22) Filed: Aug. 5, 2025

(30) Foreign Application Priority Data
Aug. 5, 2024 (CN) 202411066639.X
Aug. 5, 2024 (CN) 202421888309.4
Feb. 20, 2025 (CN) 202520280136.6

(51) Int. Cl. A47J 31/40; A47J 31/44

(52) U.S. Cl. CPC A47J 31/404; A47J 31/4403

(57) ABSTRACT

Enbodiments of the present application provide a powder outlet apparatus, which includes: a powder outlet port, a clamping assembly and a drive motor assembly, the clamping assembly includes a first clamping arm and a second clamping arm, the first clamping arm and the second clamping arm are able to be opened and closed relative to each other and cover the powder outlet port, and the clamping motor assembly is connected to the clamping member. Enbodiments of the present application also provide a milk powder dispenser. The present application can prevent accumulation of residual milk powder at the powder outlet port after powder output, and effectively ensure that the powder outlet port is clean and free of residual powder after use.

### CROSS-REFERENCE TO RELATED APPLICATIONS

The application claims priority to Chinese patent application No. 202411066639.X, filed on Aug. 5, 2024, Chinese patent application No. 202421888309.4, filed on Aug. 5, 2024 and Chinese patent application No. 202520280136.6, filed on Feb. 20, 2025, the entire contents of which are incorporated herein by reference.

### TECHNICAL FIELD

Embodiments of the present application relate to the field of mother and baby products, and in particular, to a powder outlet apparatus and a milk powder dispenser.

### BACKGROUND

As consumption level improves continuously, people have more scientific standards for the care of infants and baby children. As a kind of mother and baby products, the milk powder dispenser can control the concentration of milk powder more accurately, more sanitary and more labor-saving compared to traditional manual manners of mixing milk.

In the discharge process of the milk powder dispenser, residual milk powder may adhere to the powder outlet port, if not cleaned in time, it may accumulate and cause pollution to the next discharge process. Therefore, how to reduce residual milk powder at the powder outlet port have become a research focus of a person skilled in the art.

### SUMMARY

A powder outlet apparatus and a milk powder dispenser are provided in embodiments of the present application, to prevent milk powder from remaining at the powder outlet port.

According to a first aspect, a powder outlet apparatus is provided, the powder outlet apparatus may be applied to a milk powder dispenser, the power outlet apparatus includes a powder outlet port, a clamping member and a clamping motor assembly, the clamping member includes a first clamping arm and a second clamping arm, the first clamping arm and the second clamping arm are able to be opened and closed relative to each other and cover the powder outlet port, and the clamping motor assembly is connected to the clamping member.

In some possible implementations, the powder outlet apparatus further includes a spray assembly; and/or

the clamping motor assembly is connected to the first clamping arm by using a cam mechanism; and/or the powder outlet port is of flexible silicone rubber material; and/or

the relative meeting portions of the first clamping arm and the second clamping arm are respectively disposed as lower-step structures.

In some possible implementations, the cam mechanism includes a disc cam, a second roller, and a driven rod, the disc cam is axially connected to the output end of the clamping motor assembly; one end of the first driven rod is provided with the second roller, and the other end is connected to the rotating end of the first clamping arm; and/or

the rotating end of the first clamping arm is provided with a second driving gear, and the clamping end is provided with a first clamping plate, the rotating end of the second clamping arm is provided with a second driven gear, and the clamping end is provided with a second clamping plate, the first clamping arm and the second clamping arm engage with each other by using the second driving gear and the second driven gear.

In some possible implementations, the second driving gear and the second driven gear are both of incomplete gear structures, and the number of teeth of the first driving gear is equal to that of the first driven gear; and/or
the clamping motor assembly includes a lower plate, a champing drive motor and a upper plate, the clamping drive motor is disposed on the upper plate; the cam mechanism, the second driving gear and the second driven gear are horizontally disposed between the upper plate and the lower plate; and/or
the driven rod is disposed in the tangential direction of the disc cam; and/or
a reset spring is further horizontally disposed on the driven rod.

In some possible implementations, the arc length of the teeth is matched to the radius of the powder outlet port; and/or
the main bodies of the clamping end of the first clamping arm and the second clamping arm sink downward synchronously forming a groove structure.

In some possible implementations, the clamping end of the first clamping arm includes a first clamping section, the first clamping section is disposed between the first clamping plate and the second driving gear, the sinking depth of the first clamping plate is greater than that of the first clamping section; and/or
the clamping end of the second clamping arm includes a second clamping section, the second clamping section is disposed between the second clamping plate and the second driven gear, and the sinking depth of the second clamping plate is greater than that of the second clamping section.

In some possible implementations, the powder outlet apparatus further includes a powder removing mechanism, the powder removing mechanism includes at least one powder removing rod and a rotating member for driving the powder removing rod rotating along the inner wall of the powder outlet port, the powder removing rod includes a first powder removing section contacting with the inner wall of the powder outlet port and a second powder removing section contacting with the bottom surface of the powder outlet port.

In some possible implementations, at least one fourth protrusion is provided on the bottom surface of the powder outlet port; and/or
the rotating member is disposed around the powder outlet port, a third driven gear is disposed on the outer sidewall of the rotating member in a circumferential direction;
the powder removing mechanism includes a powder removing motor assembly engaging with the third driven gear by using an axially connected third driving gear.

In some possible implementations, the powder removing rod further includes a connecting portion, the connecting portion is fixedly connected to the rotating member, the second powder removing section below the powder outlet port extends horizontally from the connecting portion to the inner side of the powder outlet port, and the first powder removing section extends upward along the inner wall of the powder outlet port from the second powder removing section.

In some possible implementations, the rotating member is provided with at least one fixing hole disposed in a vertical direction, and the connecting portion is inserted into the fixing hole; and/or, the bottom of the powder outlet port protrudes from the rotating member.

In some possible implementations, the third driven gear is disposed at the top of the rotating member, and the fixing hole is disposed below the third driven gear; and/or
the outer sidewall of the powder outlet port is provided with a boss in a circumferential direction, and the top surface of the third driven gear is provided with a plurality of claws cooperating with the boss; and/or,
the height of the third driven gear is smaller than that of the third driving gear, and the third driven gear engages with the bottom of the third driving gear; and/or
a support platform is disposed around the powder outlet port, the powder removing motor assembly is fixedly connected to the upper side of the support platform, and the outer diameter of the third driven gear is greater than the inner diameter of the support platform.

According to a second aspect, a milk powder dispenser is provided, the milk powder dispenser includes a powder outlet apparatus, the power outlet apparatus includes a powder outlet port, a clamping member and a clamping motor assembly, the clamping member includes a first clamping arm and a second clamping arm, the first clamping arm and the second clamping arm are able to be opened and closed relative to each other and cover the powder outlet port, and the clamping motor assembly is connected to the clamping member.

In some possible implementations, the milk powder dispenser further includes a bottle holder and a bottle lifting mechanism disposed below the bottle holder, the bottle lifting mechanism includes a lifting motor assembly and a groove cam assembly or a screw rod lifting motion pair, a groove cam assembly or the screw rod lifting motion pair is connected to the lifting motor assembly, the groove cam assembly is disposed below the bottle holder and includes a cylindrical cam and a driven lifting cylinder, the cylindrical cam and the driven lifting cylinder sleeved with each other, the surface of the cylindrical cam is provided with a plurality of transmission teeth forming a first driven gear, and the lifting motor assembly engages with the first driven gear by using an axially connected first driving gear.

In some possible implementations, the base is provided with a motor mounting frame having a equal height to that of the first driving gear, the output shaft of the first lifting motor is mounted downward on the upper side of the motor mounting frame, and the first driving gear is horizontally mounted on the lower side of the motor mounting frame and axially connected to the output shaft of the first lifting motor; and/or
the first driving gear is of complete gear structure and the first driven gear is of incomplete gear structure.

In some possible implementations, the side wall surface of the cylindrical cam is further provided with an arc-shaped flange, the arc-shaped flange and the incomplete gear structure of the first driven gear meet head-to-end forming a complete circle; and/or
the transmission radius of the first driving gear is equal to the radius of the first lifting motor.

In some possible implementations, the surface of the cylindrical cam is provided with a plurality of curved grooves, the plurality of curved grooves are symmetrically distributed along the axis of the cylindrical cam, and the surface of the driven lifting cylinder is provided with at least one first roller extending into at least one of the curved groove.

In some possible implementations, the first driven gear is disposed at the bottom end of the cylindrical cam; and/or the first roller is disposed near the bottom end of the curved groove; and/or
the arc length of the first driven gear is greater than or equal to the length of the horizontal projection of a single curved groove.

In some possible implementations, the bottle lifting mechanism further includes a guide portion, the guide portion is connected to the driven lifting cylinder; and/or the bottle lifting mechanism further includes a protective sleeve, the protective sleeve extends upward above the cylindrical cam from the outer edge of the base.

In some possible implementations, the guiding portion includes at least one protruding rib and at least one pair of guide rails, the at least one protruding rib is disposed in a vertical direction on the outer surface of the driven lifting cylinder, the at least one pair of guide rails are disposed on the guide rail mounting bracket, and the protruding rib is up-and-down slidably inserted into the guide rail.

In some possible implementations, the guide rail mounting bracket includes at least one guide rail mounting plate and a guide rail fixing ring, the a least one guide rail mounting plate extends upward from the base, and the guide rail fixing ring is disposed at the top end of the at least one guide rail mounting plate; and/or
the guide rail is disposed between the cylindrical cam and the side wall of the driven lifting cylinder.

The beneficial effects of embodiments of present application are:

Embodiments of the present application control the clamping member to repeatedly clamp and loosen at the powder outlet port position by the powder output control device, so as to shake off the residual milk powder at the powder outlet port after powder output, and effectively ensure that the powder outlet port is clean and free of residual powder after use.

### BRIEF DESCRIPTION OF DRAWINGS

In order to more clearly illustrate the technical solutions in the embodiments of the present application or the prior art, the accompanying drawings required for describing the embodiments or the prior art are briefly introduced below. Obviously, the drawings described below are some embodiments of the present disclosure. For a person of ordinary skill in the art, other accompanying drawings can also be obtained based on these accompanying drawings without creative work.

FIG. 1 is a schematic diagram of a milk powder dispenser according to an embodiment of the present application;

FIG. 2 is a schematic diagram of a milk powder dispenser according to another embodiment of the present application;

FIG. 3 is a schematic diagram of a powder outlet apparatus according to an embodiment of the present application;

FIG. 4 is a schematic diagram of partial structure of a powder outlet apparatus according to an embodiment of the present application;

FIG. 5 is a schematic diagram of another angle of partial structure of a powder outlet apparatus according to an embodiment of the present application;

FIG. 6 is a sectional view of a bottle lifting mechanism according to an embodiment of the present application;

FIG. 7 is a schematic diagram of a bottom structure of a bottle lifting mechanism according to an embodiment of the present application;

FIG. 8 is a schematic diagram of the inner structure of a bottle lifting mechanism according to an embodiment of the present application;

FIG. 9 is a top view and a sectional view along A-A direction of a bottle lifting mechanism according to another embodiment of the present application;

FIG. 10 is a schematic diagram of an exploded structure of another bottle lifting mechanism according to an embodiment of the present application;

FIG. 11 is a schematic diagram of the structure of a guide rail and a drive motor assembly according to an embodiment of the present application;

FIG. 12 is a schematic diagram of the structure of a cylindrical cam according to an embodiment of the present application.

FIG. 13 is a schematic diagram of a milk powder dispenser according to another embodiment of the present application;

FIG. 14 is a sectional view of a milk powder dispenser according to another embodiment of the present application;

FIG. 15 is a schematic diagram of an exploded structure of a powder outlet port according to another embodiment of the present application;

FIG. 16 is an enlarged view of part A in FIG. 14;

FIG. 17 is a schematic diagram of a powder removing mechanism according to another embodiment of the present application;

FIG. 18 is a schematic diagram of a powder removing mechanism according to another embodiment of the present application from another perspective.

In the drawings:

1: Milk powder dispenser; 100: Bottle lifting mechanism; 110: groove cam assembly; 111: Cylindrical cam; 1111: First driven gear; 1112: Arc-shaped flange; 1113: Curved groove; 112: Driven lifting cylinder; 1121: First roller; 1122: Protruding rib; 121: Screw rod lifting motion pair; 1211: Lifting head (the head portion); 1211a: Mounting plate; 1211b: Internal thread hole column; 1212: Rotating screw rod; 130: Lifting motor assembly; 131: First driving gear; 132: First lifting motor; 133: Second lifting motor; 140: Base; 141: Guide rail mounting frame; 1411: Guide rail; 1412: Guide rail mounting plate; 1413: Guide rail fixing ring; 142: Motor mounting frame; 150: Bottle holder; 160: Protective sleeve; 170: Baby bottle; 180: Lifting portion; 181: First protrusion; 182: Second protrusion; 183: Limiting ring; 190: Mounting seat; 191: Cylinder body; 192: Partition plate; 1921: Motor mounting hole; 193: Top plate; 194: Limiting hole; 195: Reinforcing rib; 196: Third protrusion; 197: Guide rod; 200: Powdering outlet apparatus; 210: Powder outlet port; 220: Clamping member; 221: First clamping arm; 222: Second clamping arm; 221a: Rotating end of the first clamping arm; 221b: Second driving gear; 221c: First clamping plate; 221d: First clamping section; 222a: Rotating end of the second clamping arm; 222b: Second driven gear; 222c: Second clamping plate; 222d: Second clamping section; 223: Lower-step structure; 224: Groove structure; 230: Clamping motor assembly; 231: Lower plate; 232: Clamping drive motor; 233: Upper plate; 240: Cam mechanism; 241, Disc cam; 242: Second roller; 243: Driven rod; 244: Reset spring; 250: Milk powder container; 300: Milk shaking mechanism; 301: Milk shaking motor; 400: Water tank assembly; 260: Powder removing mechanism; 270: Support platform; 211: Fourth protrusion; 212: Platform; 261: Powder removing rod; 2611: First powder removing section; 2612: Second powder removing section; 2613: Connecting portion; 262: Rotating member; 2621: Third driven gear; 2622: Fixing hole; 2623: Claw; 263: Powder removing motor assembly; 2631: Third driving gear.

### DETAILED DESCRIPTION OF THE EMBODIMENTS

To make the objectives, technical solutions, and advantages of this application more clear, the following further describes this application in detail with reference to the accompanying drawings. Obviously, the described embodiments are part of the embodiments of the present disclosure, and not all of the embodiments. In the absence of conflict, the embodiments in the present disclosure and the features in the embodiments can be combined with each other. Based on embodiments of the present disclosure, all other embodiments obtained by a person of ordinary skill in the art without creative work should be the scope of the present application.

It should be noted that: in the drawings, the same or similar numbers throughout represent the same or similar elements or elements with the same or similar functions; in the description of the present disclosure, the terms “center”, “longitudinal”, “lateral”, “front”, “back”, “left”, “right”, “vertical”, “horizontal”, “top”, “bottom”, “inside”, “outside” and the like indicate the orientation or position relationship based on the orientation or position relationship shown in the drawings, which is only for the convenience of describing the present disclosure and simplifying the description, rather than indicating or implying that the device or element referred to must have a specific orientation, or be constructed and operated in a specific orientation, and therefore cannot be understood as limiting the scope of protection of the present disclosure; in the description of the present disclosure, “first”, “second”, etc. are only used to distinguish each other, rather than to indicate their importance and order, etc.

In the description of the present disclosure, unless otherwise clearly specified and limited, the terms “amounted”, “connected”, and “connection” should be understood in a broad sense, for example, it can be a fixed connection, a movable connection, or a detachable connection; it can be a mechanical connection or an electrical connection; it can be directly connected or indirectly connected through an intermediate medium, or it can be the internal connection of two components, etc. For a person of ordinary skill in the art, the specific meanings of the foregoing terms in the present disclosure can be understood in specific circumstances.

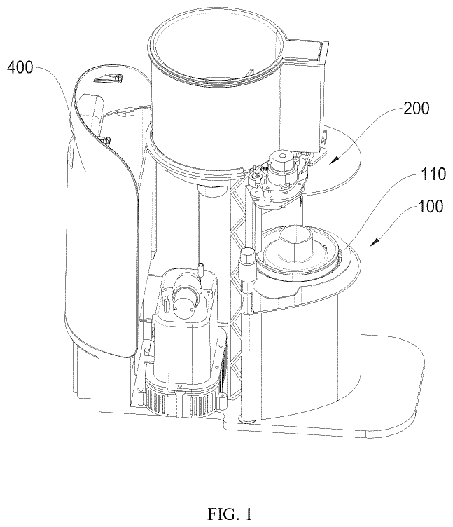

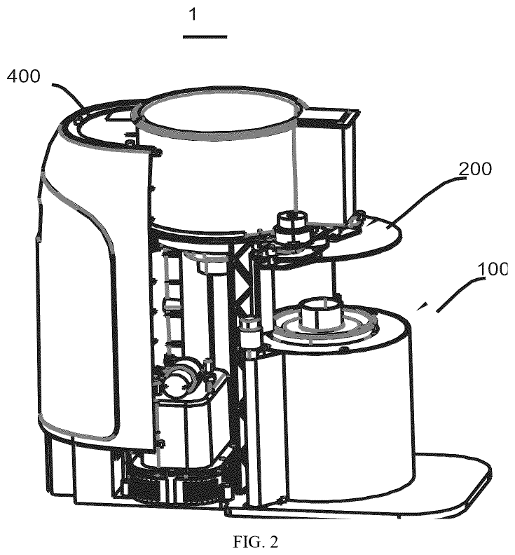

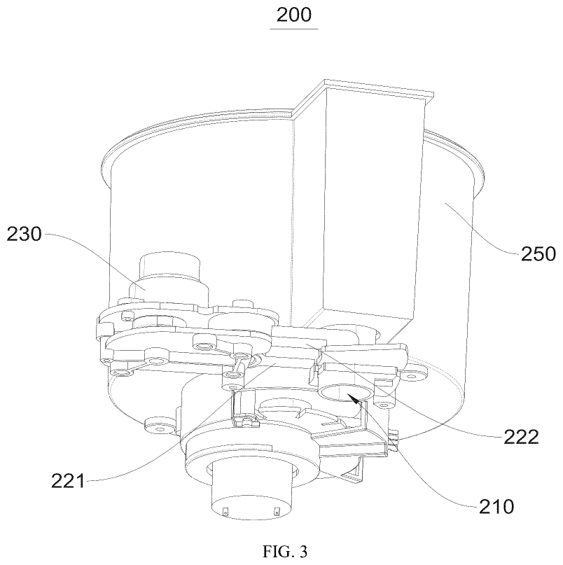

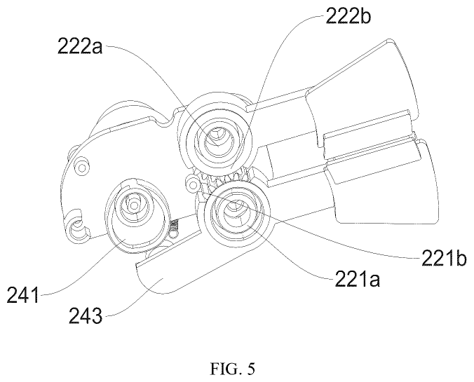

With reference to FIGS. 1 to 5, a milk powder dispenser 1 in embodiments of this application includes a powder outlet apparatus 200, the powder outlet apparatus 200 includes a powder outlet port 210, a clamping member 220, and a clamping motor assembly 230, the clamping member 220 includes a first clamping arm 221 and a second clamping arm 222, the first clamping arm 221 and the second clamping arm 222 are able to be opened and closed relative to each other and cover the powder outlet port 210, the clamping motor assembly 230 is connected to the clamping member 220. Wherein, the first clamping arm 221 and the second clamping arm 222 are respectively disposed near the powder outlet port 210, when the first clamping arm 221 and the second clamping arm 222 are closed to each other, they clamp the powder outlet port 210; when the first clamping arm 221 and the second clamping arm 222 are opened, they release the powder outlet port 210, the first clamping arm 221 and the second clamping arm 222 are respectively disposed on two sides of the powder outlet port 210 in a horizontal direction. After powder output from the powder outlet port 210 is completed, the clamping motor assembly 230 drives the first clamping arm 221 and the second clamping arm 222 repeatedly opening and closing, the powder outlet port 210 is alternately clamped and released by the clamping member 220, to shake off the milk powder adhering to the powder outlet port 210.

In some possible implementations, the powder outlet port 210 is of flexible silicone rubber flexible silicone rubber material, which is able to be pressed and clamped by the first clamping arm 221 and the second clamping arm 222 of the clamping member 220 when the clamping member 220 is closed, so as to achieve a sealing effect, and prevent the milk powder in the milk powder container 250 connected above the powder outlet port 210 from being damp.

In some possible implementations, the powder outlet apparatus 200 further includes a spray assembly (not shown in the FIG.), the airflow sprayed by the spray assembly can dislodge residual milk powder from the powder outlet port 210, specifically, the spray assembly may be incorporated into the hollow-structured first clamping arm 221 or second clamping arm 222, or independently disposed near or within the powder outlet port 210.

In some possible implementations, the clamping motor assembly 230 is connected to the first clamping arm 221 by using a cam mechanism 240, the cam mechanism 240 includes a disc cam 241, a second roller 242, and a driven rod 243, the disc cam 241 is axially connected to the output end of the clamping motor assembly 230, one end of the driven rod 243 is provided with the second roller 242, and the other end is connected to the rotating end of the first clamping arm 221a. One end of the disc cam 241 is of protruding structure from a horizontally direction, when the clamping motor assembly 230 drives the disc cam 241 rotating, and the protrusion portion of the disc cam 241 rotates to a position abutting against the driven rod 243, the driven rod 243 is open at a certain angle relative to the second clamping arm 221, thereby the driven rod 243 drives the first clamping arm 221 rotating closer to the second clamping arm 222, and the powder outlet port 210 is clamped between the first clamping arm 221 and the second clamping arm 222; a reset spring 244 is further horizontally disposed on the driven rod 243, when the protrusion portion of the disc cam 241 rotates away from the driven rod 243, the driven rod 243 is closed at a certain angle relative to the second clamping arm 221 with the traction force of the reset spring 244, the driven rod 243 drives the first clamping arm 221 rotating away from the second clamping arm 222, so that the powder outlet port 210 is released between the first clamping arm 221 and the second clamping arm 222. The second roller 242 is rotatably connected to the driven rod 243 abuts against the disc cam 241, So that the resistance and noise of the driven rod 243 and the disc cam 241 in a transmission process are reduced, the driven rod 243 is disposed in the tangential direction of the disc cam 241, the speed and acceleration of the driven rod 243 are determined by the tangential direction of contour of the disc cam 241, the designation of the disc cam 241 and the driven rod 243 tangentially touching each other enables the driven rod 243 to move smoothly, and reduces shock and vibration.

In some possible implementations, the rotating end of the first clamping arm 221a is provided with a second driving gear 221b, and the clamping end is provided with a first clamping plate 221c, the rotating end of the second clamping arm 222a is provided with a second driven gear 222b, and the clamping end is provided with a second clamping plate 222c, the first clamping arm 221 engages with the second clamping arm 222 by using the second driving gear 221b and the second driven gear 222b. In this way, the first clamping arm 221 and the second clamping arm 222 can be driven to open or close simultaneously by driving a single driven rod 243, the structure is compact, and the occupied space is reduced. Since the first clamping arm 221 and the second clamping arm 222 only need to clamp or release the powder outlet port 210, both the second driving gear 221b and the second driven gear 222b are of incomplete gear structures, and the number of teeth of the second driving gear 221b is equal to that of the second driven gear 222b, the incomplete gear structures effectively limit the opening angle of the clamping member 220, prevent them from detachment causing by opening excessive angle, and improve stability, in addition, the arc length of the teeth of the incomplete gear of the second driving gear 221b or the second driving gear 222b is disposed to match to the radius of the powder outlet port 210, to make the first clamping arm 221 and the second clamping arm 222 to clamp the powder outlet port 210 in a relatively closed manner, each compress half of the powder outlet port 210, balance the forces exerted by the first clamping arm 221 and the second clamping arm 222 on the powder outlet port 210, the deformation degree of the two side walls of the powder outlet port 210 that are clamped is roughly the same, and enable the residual milk powder at the powder outlet port 210 to fall straightly into the baby bottle 170.

In some possible implementations, the relative meeting portions of the first clamping arm 221 and the second clamping arm 222 are both disposed as Lower-step structures 223. The main bodies of the first clamping arm 221 and the second clamping arm 222 simultaneously sink downward forming groove structure 224. The clamping end of the first clamping arm 221 includes a first clamping section 221d disposed between the first clamping plate 221c and the second driving gear 221b, the sinking depth of the first clamping plate 221c is greater than that of the first clamping segment 221d; the clamping end of the second clamping arm 222 includes a second clamping section 222d disposed between the second clamping plate 222c and the second driven gear 222b, the sinking depth of the second clamping plate 222c is greater than that of the second clamping segment 222d, this two-section recessed structure enhances the rigidity of both the first clamping arm 221 and the second clamping arm 222, and the first clamping plate 221c and the second clamping plate 222c, which have a deeper sinking depth, can be closer to the end of the powder outlet port 210, and improving the rigidity and strength, for easier to shake off the milk powder adhered to the powder outlet port 210.

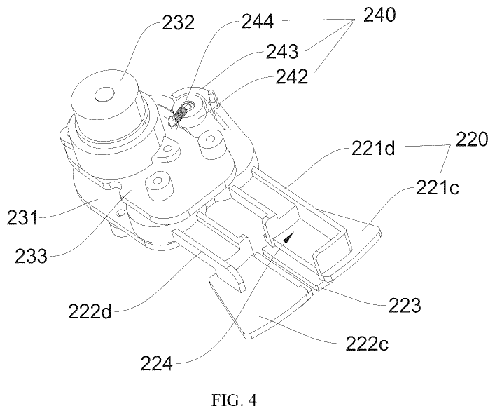

In some possible implementations, the clamping motor assembly 230 includes a lower plate 231, a clamping drive motor 232, and an upper plate 233 the clamping drive motor 232 is mounted on the upper plate 233, the cam mechanism 240, the second driving gear 221b, and the second driven gear 222b horizontally mounted between the upper plate 233 and lower plate 231. As shown in FIG. 4, the output shaft of the clamping drive motor 232 is disposed on the upper plate 233, passes through the upper side of the upper plate 233, and is axially connected to the disc cam 241. The first clamping arm 221 and the second clamping arm 222 are rotatably disposed between the upper plate 233 and the lower plate 231, to restrict vertical movement and enhance the transmission stability.

In a growth process of infants and baby children, the daily intake of milk powder continues increasing. Therefore, infants and baby children need to change bottles with different capacities, also, the designations of bottles also present various styles. Inconsistent heights of bottles may cause milk powder leakage. Therefore, bottle lifting mechanism can be set up to adapt to different bottle heights. However, currently, the bottle lifting mechanism has a complex structure and occupies a large space.

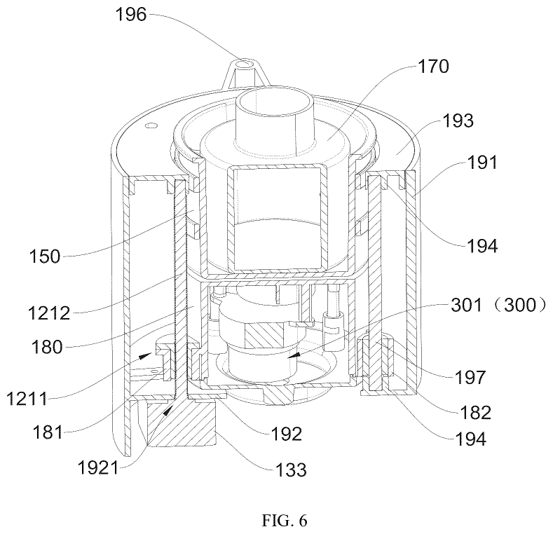

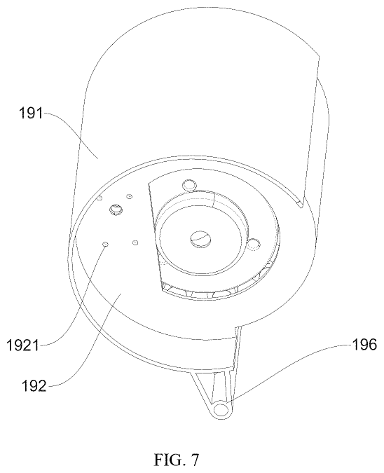

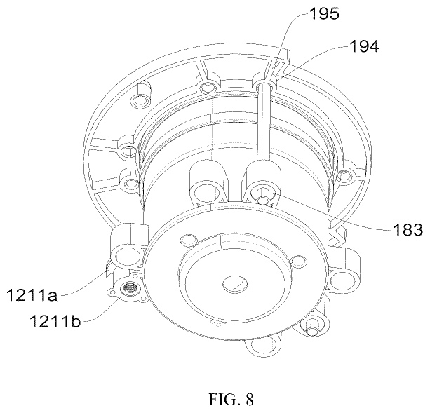

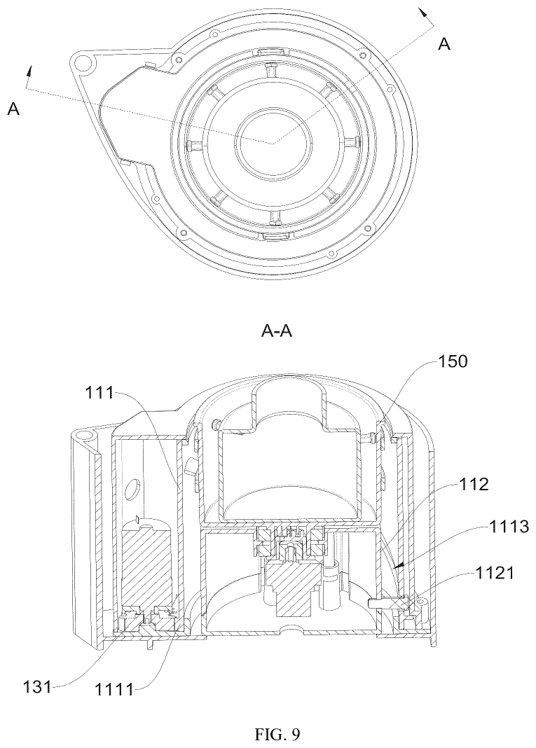

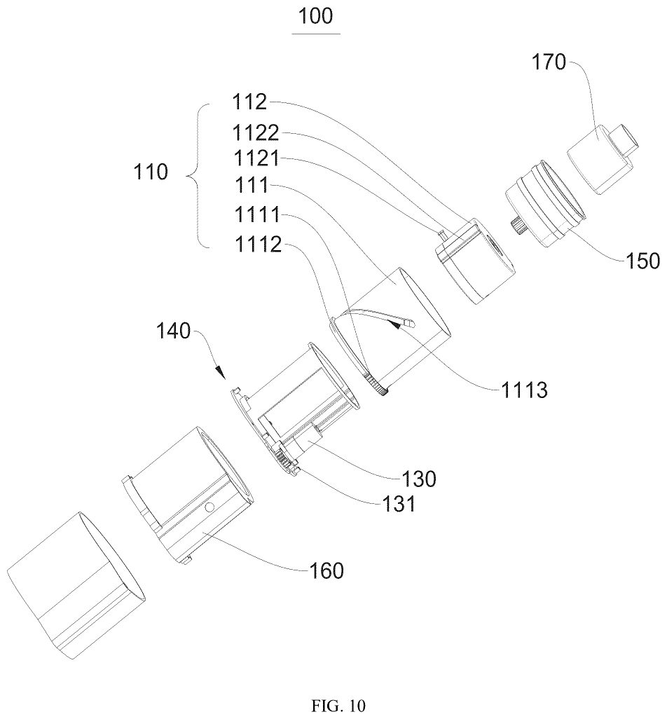

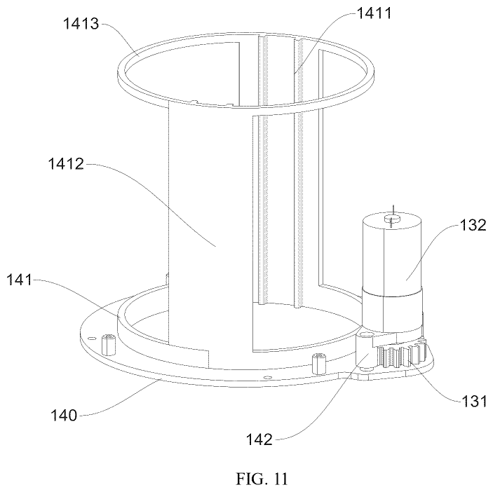

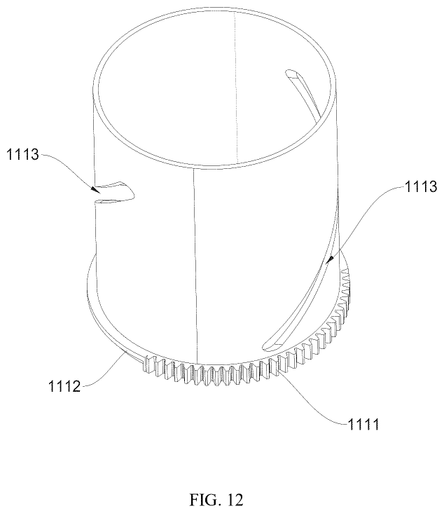

As shown in FIGS. 6 to 12, to resolve the foregoing problem, the milk powder dispenser 1 in embodiments of the present application further includes a bottle holder 150, a bottle lifting mechanism 100, and a bottle detection mechanism (not depicted) disposed at the powder outlet port 210. The bottle holder 150 is configured to fixedly hold the baby bottle 170, and the bottle lifting mechanism 100 is configured to lift the bottle holder 150 up to the powder outlet port 210 or lower the bottle holder 150 down to original position. The bottle detection mechanism is configured to detect the baby bottle 170 in the bottle holder 150.

In some possible implementations, the bottle lifting mechanism 100 includes a lifting motor assembly 130 and a groove cam assembly 110 or a screw rod lifting motion pair 121, the groove cam assembly 110 or the screw rod lifting motion pair 121 is connected to the lifting motor assembly 130.

In some possible implementations, the bottle lifting mechanism 100 further includes a hollow-structured lifting portion 180 disposed in the vertical direction. The lifting portion 180 is connected to the head portion of the screw rod lifting motion pair 121, and the milk shaking mechanism 300 is disposed within the hollow structure of the lifting portion 180. The screw rod lifting motion pair 121 is provided with a lifting head 1211 (i.e., the head portion of the screw rod lifting motion pair 121), the lifting head 1211 rigidly connected to the lifting portion 180. The screw rod lifting motion pair 121 is a mechanical device utilizing a screw-nut screw pair to convert rotational motion into linear motion, the lifting head 1211 of the screw rod lifting motion pair 121 is rigidly connected to the lifting portion 180, to enable the screw rod lifting motion pair 121 driving the lifting head 1211 by rotation, and the lifting portion 180 ascending or descending.

In some possible implementations, the outer sidewall of the lifting portion 180 is provided with a first protrusion 181, the first protrusion 181 is fixedly connected to the lifting head 1211. The screw rod lifting motion pair 121 further includes a rotating screw 1212 disposed in the vertical direction, the rotating screw 1212 is axially connected to a second lifting motor 133 and the lifting head 1211 with an internal threaded hole, the lifting head 1211 is sleeved over the rotating screw 1212 by using the internal threaded hole. The first protrusion 181 disposed on the outer sidewall of the lifting portion 180 is configured to be fixedly connected to the lifting head 1211 and load the lifting portion 180 up and down, the rotating screw 1212 is disposed in the vertical direction, to drive the lifting head 1211 ascending and descending along the rotating screw 1212 when the second lifting motor 133 drives the rotating screw 1212 rotating. The lifting head 1211 includes a mounting plate 1211a with an internal threaded hole, and the first protrusion 181 is fixed to the mounting plate 1211a, to enhance structural rigidity strength between the lifting head 1211 and the protrusion 181, and prevent detachment. The meeting surface between the mounting plate 1211a and the lifting portion 180 is disposed as a tangent plane, to make the structure between the rotating screw 1212 and the lifting portion 180 more compact. The lifting head 1211 further includes an internal thread hole column 1211b extending downward from the inner threaded hole of the mounting plate 1211a, to improve transmission stability by increasing the length of the threaded connection between the lifting head 1211 and the rotating screw 1212.

In some possible implementations, the mounting seat 190 further includes at least one guide rod 197 disposed in a vertical direction. The outer sidewall of the lifting portion 180 is provided with at least one second protrusion 182, and the at least one guide rod 197 passes through the second protrusion 182 and is fixed to the mounting seat 190. The guide rod 197 disposed in a vertical direction ensures smoother movement of the lifting portion 180 in an ascending or descending process. There may be a plurality of both the guide rod 197 and the second protrusion 182, to achieve better balance effect. In addition, a limiting ring 183 is disposed between the guide rod 197 and the second protrusion 182, to restrict the displacement of the guide rod 197 within the second protrusion 182, and enhance stability of the lifting portion 180.

In some possible implementations, the mounting seat 190 includes a cylinder 191 sleeved outside the lifting portion 180, a partition plate 192 located near the bottom of the cylinder 191, and an top plate 193 mounted at the top of the cylinder 191, the second lifting motor 133 is located below the partition plate 192, the top end of the rotating screw rod 1212 is rotatably fixed to the top plate 193, the bottom end passes through the partition plate 192 and is axially connected to the second lifting motor 133. The partition plate 192 and the top plate 193 respectively fixedly disposed at the bottom fix the rotating screw rod 1212 in a vertical direction, and serve a protective function. In addition, the partition plate 192 is provided with a motor mounting hole 1921, the second lifting motor 133 is fixedly mounted at the bottom of the partition plate 192 by using the mounting hole 1921, to achieve compact structure. The first protrusion 181 is located at the bottom of the cylinder 191, to increase the maximum height of the lifting portion 180, so as to suit for various heights of baby bottles 170. In addition, the second protrusion 182 may be located at the bottom of the cylinder 191, to balance the load distribution of the lifting portion 180 between the first protrusion 181 and the second protrusion 182.

In some possible implementations, the partition plate 192 and top plate 193 are provided with at least one group of limiting holes 194 oppositely disposed in a vertical direction, each group of limiting holes 194 are able to accommodate a rotating screw 1212 or a guide rod 197, the limiting holes 194 can limit the play of rotating screw 1212 or the guide rod 197 in a horizontal direction, and avoid the lifting portion 180 shaking in a lifting or lowering process. The limiting holes 194 are disposed protruding from the lower surface of top plate 193/the upper surface of partition 192, to increase the height of the limiting holes 194, and enhance the limiting effect. and reinforcing ribs 195 are further disposed between the limiting holes 194 and the inner wall of cylinder 191, to increase intensity of limiting holes 194.

In some possible implementations, the outer sidewall of the mounting seat 190 is further provided with a third protrusion 196, and a pin (not shown in the FIG.) fixedly connected with the outer sidewall of the mounting seat 190 can be mounted within the third protrusion 196, so that the sidewall of the mounting seat 190 can be opened along the third protrusion 196, to facilitate mounting and detaching.

In some possible implementations, the groove cam assembly 110 includes a hollow-structured cylindrical cam 111 disposed in a vertical direction, and the milk shaking mechanism 300 is housed within the hollow structure of the cylindrical cam 111. The groove cam assembly 110 includes a cylindrical cam 111 and a driven lifting cylinder 112, the cylindrical cam 111 and the driven lifting cylinder 112 are sheathed with each other, the surface of the cylindrical cam 111 is provided with transmission teeth, transmission teeth form a first driven gear 1111, while the lifting motor assembly 130 engages with the first driven gear 1111 by using an axially connected first driving gear 131. The groove on the groove cam assembly 110 is connected to the driven lifting cylinder 112, the lifting motor assembly 130 drives the first driving gear 131 rotating the first driven gear 1111, ascending or descending the driven lifting cylinder 112 when the cylindrical cam 111 rotates, by converting the rotational motion of the cylindrical cam 111 into linear motion in the vertical direction of the driven lifting cylinder 112, enable to rise up and lower down the baby bottle 170 in the bottle holder 150. When the baby bottle lifting mechanism 100 is located beneath the powder outlet port 210 of the milk powder dispenser 1, bottles of various heights can be ascended to the position of powder outlet port 210, to prevent powder leakage.

In some possible implementations, a motor mounting bracket 142 with equal height to the first driving gear 131 is disposed on the base 140, the output shaft of the first lifting motor 132 is mounted downward on the upper side of the motor mounting bracket 142, the first driving gear 131 is horizontally mounted on the lower side of the bracket and axially connected to the output shaft of the first lifting motor 132. As shown in FIG. 4, the motor mounting bracket 142 is disposed as a suspended plate structure, the first driving gear 131 is rotatably fixed to the base 140, to enhance stability of the lifting rotation drive and make the structure of the lifting motor assembly 130 compact. Correspondingly, the first driven gear 1111 is located at the bottom end of the cylindrical cam 111. and the transmission radius of the first driving gear 131 is set to match the radius of the first lifting motor 132, to make structure more compact.

In some possible implementations, the first driving gear 131 is a of complete gear structure, the first driven gear 1111 is of incomplete structure, wherein, the driving radius of the first driving gear 131 matches that of the first lifting motor 132. Since the lifting height converted by the groove cam assembly 110 correlates with the arc length of rotation of the cylindrical cam 111, in implementations of the present application, the driving radius of the bottle lifting mechanism 100 sleeved outside of the bottle is significantly greater than both the dimensions and the required lifting height of the bottle, for saving material and easy production, the first driven gear 1111 is disposed as a section of driven rack in the circumferential direction of the outer sidewall of the cylindrical cam 111, the side surface of the cylindrical cam 111 is further provided with an arc-shaped flange 1112, the arc-shaped flange 1112 and the incomplete gear structure of the first driven gear 1111 meet head-to-end forming a complete circle. The arc-shaped flange 1112 protrudes horizontally relative to the cylindrical cam 111, and the protrusion height of the arc-shaped flange 1112 shouldn't less than the teeth height of the first driven gear 1111, to prevent the first driven gear 1111 from directly contacting with the housing, and protect the first driven gear 1111.

In some possible implementations, the cylindrical cam 111 is provided with a plurality sections of curved grooves 1113, the plurality of sections of curved grooves 1113 are distributed symmetrically along the axis of cylindrical cam 111, the driven lifting cylinder 112 is provided with at least one first roller 1121 that extends into at least one of the curved grooves. The curved grooves 1113 extend upward in the circumferential direction of cylindrical cam 111, the plurality of sections of symmetric curved grooves 1113 can make balance force, to make transmission of the bottle lifting mechanism 100 more smooth and steady, the first roller 1121 can reduce the friction during sliding in the groove, enhance transmission efficiency, and reduce motor power consumption. The first roller 1121 is disposed near the bottom end of the curved groove 1113, to increase the maximum height of the ascending and descending movement of the driven lifting cylinder 112, and suit for various sizes of baby bottles 170. The arc length of the incomplete gear structured first driven gear 1111 is greater than or equal to the length of the horizontal projection of a single curved groove 1113. in a process of the bottle lifting mechanism 100 working, the horizontal displacement of the first roller 1121 along the curved groove 1113 is equal to the rotation arc length of the first driven gear 1111, to improve the utilization of the curved groove 1113, the arc length of the first driven gear 1111 should greater than or equal to the length of the horizontal projection of a single curved groove 1113.

In some possible implementations, the bottle lifting mechanism 100 further includes a guide portion connected to the driven lifting cylinder 112. The bottle lifting mechanism 100 further includes a protective sleeve 160, protective sleeve 160 extends upward above the cylindrical cam 111 from the outer edge of the base 140. Specifically, the guide portion includes at least one protruding rib 1122 and at least one pair of guide rails 1411, the at least one protruding rib 1122 is disposed on the outer surface of the driven lifting cylinder 112 in a vertical direction, and the at least one pair of guide rails 1411 are disposed on the rail mounting frame 141, the protruding ribs 1122 up-and-down slidably extend into the guide rails 1411. Both the guide rails 1411 and protruding ribs 1122 are disposed in a vertical direction, to restrict the play in a horizontal direction of the driven lifting cylinder 112, and ensure it raising and lowering smoothly and steadily along the guide rails 1141. To enhance the strength of the guide rails 1141, the rail mounting frame 141 includes at least one rail mounting plate 1412 and a rail fixing ring 1413, the at least one rail mounting plate 1412 extends upward from the base 140, and the rail fixing ring 1413 is disposed on the top of the at least one rail mounting plate 1412, in addition, the guide rail 1411 can be disposed between the cylindrical cam 111 and the side wall of the driven lifting cylinder 112, to make the structure more compact. The mounting plates 1412 can enhance the strength of the guide rail 1411, when a plurality of rail mounting plates 1412 are provided for balanced guidance, a plurality of guide rails 1411 should be correspondingly provided. The rail fixing ring 1413 can prevent the plurality of guide rails 1411 from shaking, to enhance guidance stability.

The milk powder dispenser 1 provided in this application further includes a milk shaking mechanism 300 and a water tank assembly 400 located beneath the bottle holder 150. The milk shaking mechanism 300 is configured to mix the milk powder liquid in baby bottle 170, and the water tank assembly 400 is configured to output water to the baby bottle 170. The milk shaking mechanism 300 includes a shaking motor 301 configured to drive the bottle holder 150 rotating forward or backward.

A powder output control method is provided in embodiments of the present application. For ease of understanding, the following first describes an application scenario of the powder output control method. The powder output control method may be applied to any of the foregoing implementations of the milk powder dispenser 1. The milk powder dispenser 1 includes a bottle holder 150, a powder outlet apparatus 200 having a powder outlet port 210 and a clamping member 220. It can be understood that, the present application can be implemented in various forms and should not be limited to the illustrated embodiments herein.

The method includes:

Raising the bottle placed on the bottle holder to the position of the powder outlet port;

Specifically, the height which the bottle needs ascending can be preset based on the bottle height; or using a detection mechanism to detect the position of the baby bottle and stop ascending the baby bottle when it reaches the position of the powder outlet port; or detecting the height of bottle mouth, and determining the height that the bottle needs ascending by calculating the distance between the bottle mouth and the powder outlet port.

Driving the clamping member disposed outside the powder outlet port loosening, and start a powder output process;

Specifically, the powder outlet port is of flexible silicone material that can be tightly sealed by the clamping member, before powder output starts, the power outlet port remains in a sealed state under the grip of the clamping member to prevent milk powder from getting damp. When the baby bottle rises to the position of the powder outlet port, the clamping member loosens the power outlet port, and the powder outlet apparatus starts powder output.

After a powder output process is completed, drive the clamping member repeatedly clamping and loosening to open the powder outlet port, to enable the residual milk powder at the powder outlet port 210 to fall into the baby bottle;

In a possible implementation, an action of the clamping member clamping and loosening the powder outlet port can be completed in the following manner:

By driving the cam mechanism connected to the clamping member rotating one circle, complete an action of clamping and loosening the powder outlet port.

When the clamping motor assembly drives the cam mechanism rotating one circle, the disc cam of the cam mechanism drives the driven rod completing an action of opening and reset, i.e. the claiming member completes an action of clamping and loosening the powder outlet port. By driving the cam mechanism continuously rotating, the clamping member can implement repeatedly claiming and loosening the powder outlet port, to enable residual milk powder at the powder outlet port to fall into the baby bottle, which just needs keeping the output shaft of the clamping motor assembly rotating in one direction, the structure is simple and easy to implement.

Driving the clamping member to clamp the powder outlet port to ensure it in a sealed state, and controlling the bottle holder descending to original position.

In some possible implementation, an action of champing/loosening the powder outlet port is completed by rotating the cam mechanism connected to the clamping member from bottom point to top point/from top point to bottom point. Specifically, when starts powder output and the powder outlet port needs opening, the clamping motor assembly drives the cam mechanism rotating from the bottom point of the disc cam to the driven rod position, the driven rod is reset and the clamping member is driven to loosen the powder outlet port, to enable milk powder falling smoothly into the baby bottle from the powder outlet port; when the clamping member stops repeatedly clamping and loosening the powder outlet port, if the champing member is in an open state, the clamping motor assembly rotates the cam mechanism rotating from the bottom point to top point, i.e. the cam mechanism rotates to the protrusion portion and abuts against the driven rod, drives the champing member tightly clamping the powder outlet port, to prevent milk powder in the milk powder dispenser from being damping. Then lowering the bottle holder down to original position, for easy to take out the baby bottle within the bottle holder.

In some possible implementation, the stop condition of driving the clamping member to clamp and repeatedly loosen the powder outlet port is: detecting that the amount of residual milk powder at the powder outlet port is less than a preset threshold.

After the clamping member stops repeatedly clamping and loosening the powder outlet port, due to electrostatic interaction, some milk powder may adhere to the powder outlet port without falling off, in order to clean the residual milk powder, in some possible implementations, the method further includes the following steps:

Drive sprayer disposed at the powder outlet port spraying airflow into the powder outlet port, spraying off the residual milk powder at the powder outlet port into the baby bottle. To save energy, after the clamping member stops repeatedly clamping and loosening the powder outlet port and the residual milk powder is detected, then drive the sprayer spraying airflow into the powder outlet port.

In some possible implementations, controlling the baby bottle placed on the bottle holder to rise to the position of the powder outlet port by the following steps:

Driving the bottle lifting mechanism 100 disposed beneath the bottle holder ascending, to raise up the bottle holder 150 and the baby bottle 170;

After the bottle detection mechanism located at the powder outlet port detects the baby bottle, stopping ascending the bottle lifting mechanism.

Wherein, the bottle detection mechanism may be visual sensors, infrared sensors, or other detection mechanisms, this is not specifically limited in this application. When the bottle lifting mechanism is driven, the bottle detection mechanism detects the position of the bottle holder, specifically, detects the position of the baby bottle mouth, to enable the baby bottle to ascend to the position aligning with the powder outlet port, or a little bit higher than the bottom end of the powder outlet port, so as to enable milk powder to fall into baby bottle as more as possible.

In some possible implementations, the method further includes the following steps:

Driving the bottle lifting mechanism ascending by controlling the lifting motor assembly rotating forward; driving the bottle lifting mechanism descending by controlling the lifting motor assembly reversal.

Specifically, the lifting motor can be the foregoing first lifting motor or the second lifting motor, which are respectively configured to drive the cylindrical cam or rotating screw rotating, to drive the bottle holder ascending and descending.

A milk powder output control method in embodiments of the present application further includes:

Outputting water before starting powder output;

Specifically, before opening the powder outlet port, the water tank assembly injects water at an appropriate temperature into the baby bottle, separating water output from powder output, to prevent the clamping member from being wet in a clamping process, which may affect powder output.

In a powder output process, driving the milk shaking mechanism shaking the milk;

Specifically, drive the milk shaking motor of the milk shaking mechanism rotating to drive the bottle holder shaking milk. Furthermore, drive the milk shaking motor rotating forward or backward at regular intervals, to fully mix and shake the milk powder liquid in the baby bottle.

The starting condition of controlling the bottle holder descending to original position is: completing milk shaking.

Specifically, after completes milk shaking, drives the lifting motor assembly reversal to descending the bottle holder to original position, for easy to take out the baby bottle and place the baby bottle next time.

A powder output control device in embodiments of the present application includes a processor configured to execute the powder output control method described in any of the foregoing implementations. The processor may be a Central Processing Unit (CPU), Network Processor (NP), or other integrated circuits.

The processor is configured to control the bottle placed on the bottle holder ascending to the position of the powder outlet port;

The processor is configured to drive the clamping member disposed outside the powder outlet port loosening the powder outlet port and start powder output;

The processor is configured to drive the clamping member to clamp repeatedly and loosen the powder outlet port after powder output is completed, to enable the residual milk powder at the powder outlet port to fall into the baby bottle;

The processor is configured to drive the clamp member clamping the powder outlet port into a sealed state and control the bottle holder descending to original position.

In some possible implementations, the processor is configured to drive a sprayer located at the powder outlet port spraying airflow into the powder outlet port, to spray off the residual milk powder from the powder outlet port into the baby bottle.

In some possible implementations, the processor is configured to detect the residual milk powder in the powder outlet port.

In some possible implementations, the processor is configured to drive the bottle lifting mechanism beneath the bottle holder ascending, drive both the bottle holder and the baby bottle ascending; the processor is further configured to control the bottle lifting mechanism stopping ascending, specifically, the processor is further configured to detect the information of the baby bottle by using the bottle detection mechanism located at the position of the powder outlet, when the bottle detection mechanism detects that the baby bottle has reached this position, the processor immediately halts the ascent process.

In some possible implementations, the processor is configured to drive a cam mechanism connected to the clamping member rotating one circle, to complete a action of clamping and loosening the powder outlet port; in addition, the processor is configured to drive the cam mechanism connected to the clamping member rotating from the bottom point to the top point/from the top point to the bottom point, to complete a action of clamping/loosening the powder outlet port.

In some possible implementations, the processor is configured to drive the bottle lifting mechanism ascending by controlling the lifting motor rotating forward, and to drive the bottle lifting mechanism descending by controlling the lifting motor rotating backward.

In some possible implementations, the processor is configured to control water output before start powder output;
in a powder output process, drive the milk shaking mechanism shaking the milk.

A powder output control apparatus in embodiments of the present application includes:
a bottle lifting unit, configured to control the bottle placed on the bottle holder ascending to the position of the powder outlet port;
a clamping unit, configured to drive a clamping member disposed outside the powder outlet port loosening the powder outlet port, start a powder output process; the clamping unit is further configured to drive the powder outlet port repeatedly clamping and loosening after a powder output process is completed, to enable the residual milk powder at the powder outlet port to fall into the baby bottle; the clamping unit is further configured to drive the clamping member to clamping the powder outlet port into a sealed state; the bottle lifting mechanism is further configured to control the bottle holder descending to original position.

In some possible implementations, the powder output control apparatus further includes a spray unit configured to drive a sprayer located at the powder outlet port spraying airflow into the powder outlet port, to spray off the residual milk powder at the powder outlet port into the baby bottle.

In some possible implementations, the powder output control apparatus further includes a milk powder detection unit configured to detect residual milk powder at the powder outlet port; the milk powder detection unit is further configured to detect that the amount of residual milk powder in the powder outlet port is less than a preset threshold.

In some possible implementations, the powder output control apparatus further includes a bottle detection unit configured to detect the bottle having reached the position of the powder outlet port.

In some possible implementations, the clamping unit is configured to complete a single action of clamping/loosening the powder outlet port by driving the cam mechanism connected to the clamping member rotating one circle; the clamping unit is further configured to complete a single action of clamping/loosening the powder outlet port by driving the cam mechanism rotating from bottom point to top point/from top point to bottom point.

In some possible implementations, the bottle lifting unit is configured to drive the bottle lifting mechanism ascending by controlling the lifting motor assembly rotating forward; the bottle lifting unit is further configured to drive the bottle lifting mechanism descending by controlling the bottle lifting motor rotating backward.

In some possible implementations, the powder output control apparatus further includes a water output unit and a milk shaking unit, the water output unit is configured to output water before starts powder output process; the milk shaking unit is configured to drive the milk shaking mechanism shaking the milk in a powder output process.

Embodiments of the present application also provide a milk powder disposer 1, the milk powder disposer 1 includes the powder output control apparatus of any one of the possible implementations of each of the foregoing embodiments.

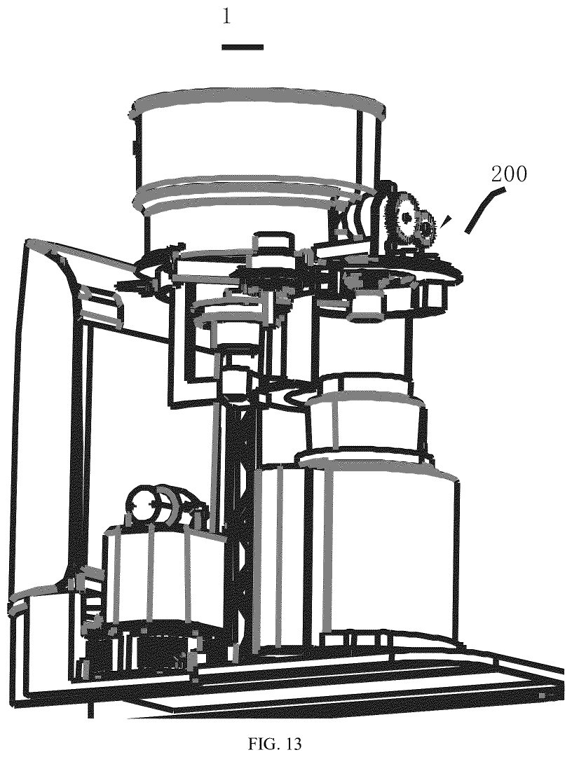

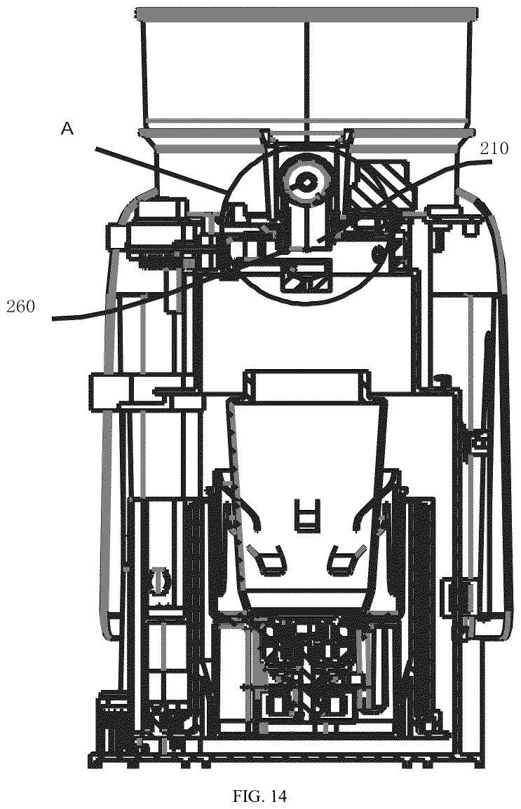

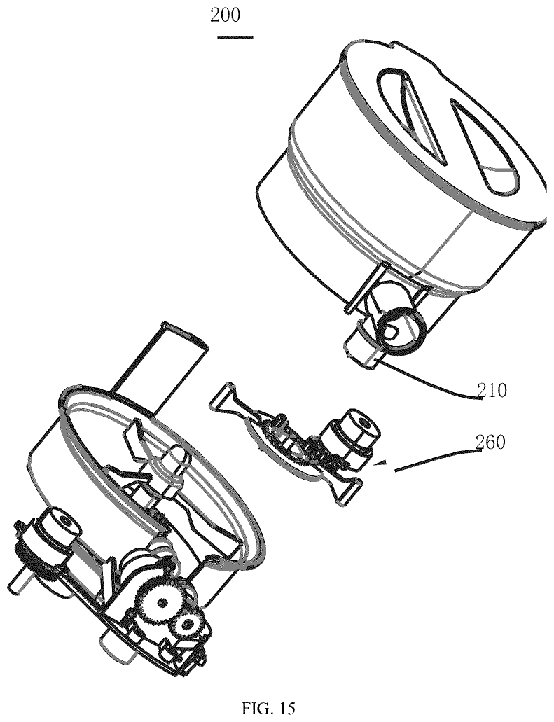

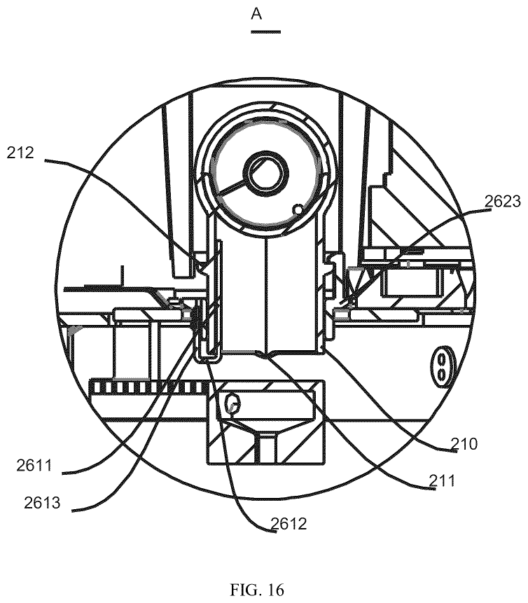

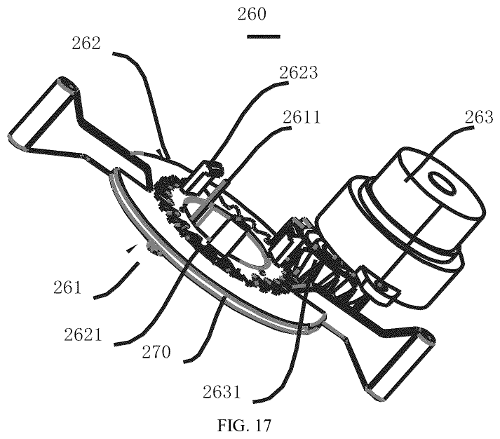

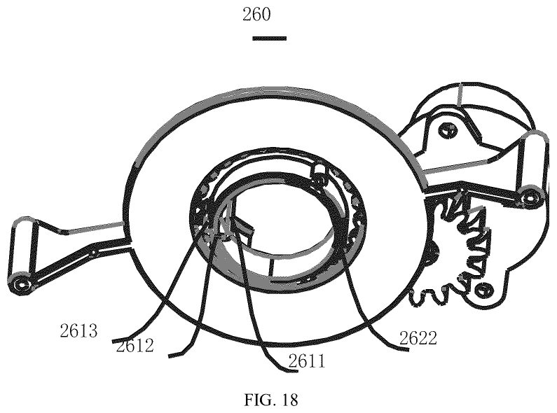

With reference to FIG. 13 to FIG. 18, a powder outlet apparatus 200 in the embodiments of the present application includes a powder outlet port 210 and a powder removing mechanism 260, the powder removing mechanism 260 includes at least one powder removing rod 261 and a rotating member 262 driving the powder removing rod 261 rotating along the inner wall of the powder outlet port 210, the powder removing rod 261 includes a first powder removing section 2611 contacting with the inner wall of the powder outlet port 210.

In a process of the milk powder output through the powder outlet port 210, the rotating member 262 drives the powder removing rod 261 rotating along the powder outlet port 210.

The first powder removing section 2611 of the powder removing rod 261 extends into the powder outlet port 210 to scrape against the inner wall, so as to scrape off the milk powder adhering to the inner wall of the powder outlet port 210 and prevent milk powder from remaining at the end of the powder outlet port 210. After the powder output is completed, the scraping operation can continue to prevent powder from leaving a residue.

In some possible implementations, the powder removing rod 261 includes a second powder removing section 2612 contacting with the bottom surface of the powder outlet port 210.

In the rotation process of the powder removing rod 261, the second powder removing section 2612 scrapes against the bottom surface of the powder outlet port 210, so as to prevent milk powder from remaining at the end of the powder outlet port 210 in a process of milk power falling down, and enhance powder removing effect.

In some possible implementations, the bottom surface of powder outlet port 210 is provided with at least one fourth protrusion 211, when the powder removing rod 261 rotates around the powder outlet port 210, the second powder removing section 2612 continuously strikes the fourth protrusions 211 on the bottom surface of the powder outlet port 210. This vibration causes the powder outlet port 210 shaking, in this way, the residual milk powder adhered by static electricity is shaken off and the powder removing efficiency is enhanced. In addition, vibration frequency of the powder outlet port 210 can be increased by setting a plurality of the fourth protrusions 211, to achieve even better powder removing results.

In a process of implementing the present application, the inventor discovered that, it would occupy significant space if the drive assembly of the powder removing mechanism 260 is located near or below the powder outlet port 210. In a milk powder output process, the distance between the bottle holder and the powder outlet port 210 becomes excessive due to the drive assembly, which is easy to leading powder leakage. To resolve the foregoing problem, in some possible implementations, the rotating member 262 is disposed around the powder outlet port 210, the outer sidewall of the rotating member 262 is provided with a third driven gear 2621 in a circumferential direction. The powder removing mechanism 260 includes a powder removing motor assembly 263 that engages with the third driven gear 2621 by using an axially connected third driving gear 2631. By setting the structure of the rotating member 262 rotating around the powder outlet port 210 through gear transmission, the occupied space of the powder removing mechanism 260 is reduced, and the bottle holder can be ascended to align with the powder outlet port 210, powder leakage is effectively prevented.

In some possible implementations, the powder removing rod 261 further includes a connecting portion 2613, the connecting portion 2613 is fixedly connected to the rotating member 262, the second powder removing section 2612 below the powder outlet port 210 extends horizontally from the connecting portion 2613 into the inner side of the powder outlet port 210, the first powder removing section 2611 extends upward along the inner wall of the powder outlet port 210 from the second powder removing section 2612. In this way, the structure of the powder removing rod 261 match to the powder outlet port 210, which make structure even more compact.

In some possible implementations, the rotating member 262 has a fixing hole 2622 disposed in a vertical direction, and the connecting portion 2613 is inserted into the fixing hole 2622, so as to enhance rigid strength of the powder removing rod 261 and reduce vibration of the powder removing rod 261 in a rotation process.

In some possible implementations, the bottom of the powder outlet port 210 protrudes from the rotating member 262, so as to prevent milk powder from sticking to the rotating member 262.

In some possible implementations, the driven gear 2621 is disposed on the top of the rotating member 262, and the fixing hole 2622 is disposed below the third driven gear 2621, so that the transmission assembly of the rotating member 262 can be placed above the powder outlet port 210, to prevent the milk powder from blocking the driven gear 2621 and affecting the powder removing.

In some possible implementations, a boss 212 is disposed in the circumferential direction on the outer sidewall of the powder outlet port 210, and a plurality of claws 2623 are disposed on the top surface of the third driven gear 2621 to cooperate with the boss 212. The claws 2623 clamp the rotating member 262 onto the outer sidewall of the powder outlet port 210, so as to enhance the stability of the rotating member 262.

In some possible implementations, the height of the third driven gear 2621 is smaller than that of the third driving gear 2631, and the bottom of the third driven gear 2621 engages with the bottom of the third driving gear 2631, to reduce the space and weight occupied by the third driving gear 2631, and reduce the resistance in the rotation process of the rotating member 262.

In some possible implementations, a support platform 270 is disposed around the powder outlet port 210. The powder removing motor assembly 263 is fixedly connected to the upper surface of the support platform 170, and the outer diameter of the third driven gear 2621 is greater than the inner diameter of the support platform 270. The powder removing motor assembly 263 may be located above the powder outlet port 210, so as to reduce the space occupied by the powder removing motor assembly 263 below the powder outlet port 210. In this way, the bottle lifting mechanism 100 of the milk powder dispenser 1 can be ascended to a height where the baby bottle mouth aligns with the powder outlet port 210, and the support platform 270 prevents the rotating member 262 from detaching.

Embodiments of the present application also provide a milk powder disposer 1, the milk powder disposer 1 includes the powder outlet apparatus of any one of the possible implementations of each of the foregoing embodiments.

Embodiments of the present application also provide a computer-readable storage medium, the computer-readable storage medium is configured to store computer program codes that, when the computer program code is run on a computer, causes the computer to perform a method of any one of the possible implementations of each of the foregoing embodiments.

Embodiments of the present application also provide a computer program product, the computer program product includes computer program codes that, when the computer program code is run on a computer, causes the computer to perform a method of any one of the possible implementations of each of the foregoing embodiments.

Embodiments of the present application also provide a computer program that, the computer program product includes computer program codes that, when the computer program code is run on a computer, causes the computer to perform a method of any one of the possible implementations of each of the foregoing embodiments.

A person of ordinary skill in the art should appreciate that, in one or more of the foregoing examples, the functions described in the embodiments of the present application may be implemented by using hardware, software, firmware, or any combination thereof. When implemented by using software, the functions may be stored in a computer-readable medium or transmitted as one or more instructions or code on a computer-readable medium. The computer-readable media includes computer storage media and communication media, the communication media includes any medium that facilitates the transmission of a computer program from one location to another. The storage medium may be any usable medium which is accessible for any general or specialized computer.

It should be noted that the foregoing descriptions are only examples of embodiments of the present disclosure and the technical principles used. A person of ordinary skill in the art should understand that the present disclosure is not limited to the specific embodiments described herein, and that various obvious changes, readjustments, and substitutions can be made by a person of ordinary skill in the art without departing from the scope of protection of the present disclosure. Therefore, although the present disclosure is described in more detail through the above embodiments, the present disclosure is not limited to the foregoing embodiments, and may include additional equal embodiments without departing from the concept of the present disclosure, and the scope of the present disclosure is determined by the scope of the attached claims.

What is claimed is:

1. A powder outlet apparatus, used for a milk powder dispenser, wherein the power outlet apparatus comprises a powder outlet port, a clamping member, and a clamping motor assembly, the clamping member comprises a first clamping arm and a second clamping arm, the first clamping arm and the second clamping arm are able to be opened and closed relative to each other and cover the powder outlet port, and the clamping motor assembly is connected to the clamping member.

2. The powder outlet apparatus according to claim 1, wherein the powder outlet apparatus further comprises a spray assembly; and/or
the clamping motor assembly is connected to the first clamping arm by using a cam mechanism; and/or
the powder outlet port is of flexible silicone rubber material; and/or
the relative meeting portions of the first clamping arm and the second clamping arm are respectively disposed as lower-step structures.

3. The powder outlet apparatus according to claim 2, wherein the cam mechanism comprises a disc cam, a second roller and a driven rod, the disc cam is axially connected to the output end of the clamping motor assembly, one end of the driven rod is provided with the second roller, and the other end is connected to the rotating end of the first clamping arm; and/or
the rotating end of the first clamping arm is provided with a second driving gear, and the clamping end is provided with a first clamping plate, the rotating end of the second clamping arm is provided with a second driven gear, and the clamping end is provided with a second clamping plate, the first clamping arm and the second clamping arm engage with each other by using the second driving gear and the second driven gear.

4. The powder outlet apparatus according to claim 3, wherein both the second driving gear and the second driven gear are of incomplete gear structures, and the number of teeth of the second driving gear is equal to that of the second driven gear; and/or
the clamping motor assembly comprises a lower plate, a clamping drive motor, and a upper plate, the champing drive motor is disposed on the upper plate; the cam mechanism, the second driving gear and the second driven gear are horizontally disposed between the upper plate and the lower plate; and/or
the driven rod is disposed in the tangential direction of the disc cam; and/or
a reset spring is further horizontally disposed on the driven rod.

5. The powder outlet apparatus according to claim 4, wherein the arc length of teeth is matched to the radius of the powder outlet port; and/or
the main bodies of the clamping end of the first clamping arm and the second clamping arm sink downward synchronously forming groove structure.

6. The powder outlet apparatus according to claim 5, wherein the clamping end of the first clamping arm comprises a first clamping section, the first clamping section is disposed between the first clamping plate and the second driving gear, the sinking depth of the first clamping plate is greater than that of the first clamping section; and/or
the clamping end of the second clamping arm comprises a second clamping section, the second clamping section is disposed between the second clamping plate and the second driven gear, and the sinking depth of the second clamping plate is greater than that of the second clamping section.

7. The powder outlet apparatus according to claim 1, wherein further comprising a powder removing mechanism, the powder removing mechanism comprises at least one powder removing rod and a rotating member for driving the powder removing rod rotating along the inner wall of the powder outlet port, the powder removing rod comprises a first powder removing section contacting with the inner wall of the powder outlet port and a second powder removing section contacting with the bottom surface of the powder outlet port.

8. The powder outlet apparatus according to claim 7, wherein at least one fourth protrusion is provided on the bottom surface of the powder outlet port; and/or
the rotating member is disposed around the powder outlet port, a third driven gear is disposed on the outer sidewall of the rotating member in the circumferential direction;
the powder removing mechanism comprises a powder removing motor assembly engaging with the third driven gear by using an axially connected third driving gear.

9. The powder outlet apparatus according to claim 8, wherein the powder removing rod further comprises a connecting portion, the connecting portion is fixedly connected to the rotating member, the second powder removing section below the powder outlet port extends horizontally from the connecting portion to the inner side of the powder outlet port, and the first powder removing section extends upward along the inner wall of the powder outlet port from the second powder removing section.

10. The powder outlet apparatus according to claim 9, wherein the rotating member is provided with at least one fixing hole disposed in a vertical direction, and the connecting portion is inserted into the fixing hole; and/or, the bottom of the powder outlet port protrudes from the rotating member.

11. The powder outlet apparatus according to claim 10, wherein the third driven gear is disposed at the top of the rotating member, and the fixing hole is disposed below the third driven gear; and/or the outer sidewall of the powder outlet port is provided with a boss in a circumferential direction, and the top surface of the third driven gear is provided with a plurality of claws cooperating with the boss; and/or,
the height of the third driven gear is smaller than that of the third driving gear, and the third driven gear engages with the bottom of the third driving gear; and/or
a support platform is disposed around the powder outlet port, the powder removing motor assembly is fixedly connected to the upper side of the support platform, and the outer diameter of the third driven gear is greater than the inner diameter of the support platform.

12. A milk powder dispenser, wherein comprising a powder outlet apparatus, the power outlet apparatus comprises a powder outlet port, a clamping member, and a clamping motor assembly, the clamping member comprises a first clamping arm and a second clamping arm, the first clamping arm and the second clamping arm are able to be opened and closed relative to each other and cover the powder outlet port, and the clamping motor assembly is connected to the clamping member.

13. The milk powder dispenser according to claim 12, wherein further comprising a bottle holder and a bottle lifting mechanism disposed below the bottle holder, the bottle lifting mechanism comprises a lifting motor assembly and a groove cam assembly or a screw rod lifting motion pair, the groove cam assembly or the screw rod lifting motion pair is connected to the lifting motor assembly, the groove cam assembly is disposed below the bottle holder and comprises a cylindrical cam and a driven lifting cylinder, the cylindrical cam and the driven lifting cylinder sleeved with each other, the surface of the cylindrical cam is provided with a plurality of transmission teeth forming a first driven gear, and the first lifting motor assembly engages with the first driven gear by using an axially connected first driving gear.

14. The milk powder dispenser according to claim 13, wherein the base is provided with a motor mounting frame having a equal height to that of the first driving gear, the output shaft of the first lifting motor is mounted downward on the upper side of the motor mounting frame, and the first driving gear is horizontally mounted on the lower side of the motor mounting frame and axially connected to the output shaft of the first lifting motor; and/or
the first driving gear is of complete gear structure and the first driven gear is of incomplete gear structure.

15. The milk powder dispenser according to claim 14, wherein the side wall surface of the cylindrical cam is further provided with an arc-shaped flange, the arc-shaped flange and the incomplete gear structure of the first driven gear meet head-to-end forming a complete circle; and/or
the transmission radius of the first driving gear is equal to the radius of the first lifting motor.

16. The milk powder dispenser according to claim 15, wherein the surface of the cylindrical cam is provided with a plurality of curved grooves, the curved grooves are symmetrically distributed along the axis of the cylindrical cam, and the surface of the driven lifting cylinder is provided with at least one first roller extending into at least one of the curved grooves.

17. The milk powder dispenser according to claim 16, wherein the first driven gear is disposed at the bottom end of the cylindrical cam; and/or the first roller is disposed near the bottom end of the curved groove; and/or the arc length of the first driven greater than or equal to the length of the horizontal projection of a single curved groove.

18. The milk powder dispenser according to claim 13, wherein the bottle lifting mechanism further comprises a guide portion, the guide portion is connected to the driven lifting cylinder; and/or the bottle lifting mechanism further comprises a protective sleeve, the protective sleeve extends upward above the cylindrical cam from the outer edge of the base.

19. The milk powder dispenser according to claim 18, wherein the guiding portion comprises at least one protruding rib and at least one pair of guide rails, the at least one protruding rib is disposed in a vertical direction on the outer surface of the driven lifting cylinder, the at least one pair of guide rails are disposed on the guide rail mounting bracket, and the protruding rib is up-and down slidably inserted into the guide rail.

20. The milk powder dispenser according to claim 19, wherein the guide rail mounting bracket comprises at least one guide rail mounting plate and a guide rail fixing ring, the a least one guide rail mounting plate extends upward from the base, and the guide rail fixing ring is disposed at the top end of the at least one guide rail mounting plate; and/or the at least one guide rail is disposed between the cylindrical cam and the side wall of the driven lifting cylinder.
